(19) United States
(12) Patent Application Publication
(10) Pub. No.: US 2006/0112077 A1
(43) Pub. Date: May 25, 2006

(54) User interface system and method providing a dynamic selection menu

(76) Inventors: Cheng-Tao Li, Hsinchu (TW); Chih-Chung Lee, Hsinchu (TW); Yu-Hwua Ma, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/994,049

(22) Filed: Nov. 19, 2004

(51) Int. Cl. G06F 17/30

(52) U.S. Cl. 707/3

(57) ABSTRACT

A system of providing a dynamic selection menu is provided. An input/output device receives a first fragment comprising a portion of a desired entry. A processor identifies and rearranges a first subset of entries, and identifying a first entry in the first subset. A display device displays the rearranged first subset of entries with the first entry highlighted.

### BACKGROUND

The invention relates generally to user interfaces for data storage and retrieval systems, and in particular to a system and method providing a control window for navigating and implementing a dynamic selection menu.

When working with a computer application, users are called upon to select a particular entry from a list, menu, or outline of possible choices. One conventional method to effect this operation simply requires users to type in the desired selection. Some designers have attempted to make this process more convenient by allowing users to indicate one choice from among many by moving a cursor to the desired entry and then pressing a special key to indicate that the entry at the cursor is to be selected. Another application has provided the possibility whereby a truncated version or abbreviation of a desired command may be entered thus making the selection with fewer keystrokes. Still another application has provided a method whereby successive keystrokes entered by the user narrows the displayed range and the available set of options. None of conventional methods, however, can facilitate the selection and provide a proper range of options.

Based on the foregoing, there is a clear need in this field for a system and method for simplifying selection and providing ready access to previous selections.

### SUMMARY

An embodiment of the invention provides a method of generating a dynamic selection menu, displaying and highlighting dynamically changing values to reflect successive keystrokes entered by a user. The method is implemented in a computer system linking to a database storing a plurality of entries associated with corresponding characteristic information. First, criteria for selection and sorting operations are provided. A first fragment, comprising a portion of a desired entry, is then received. A first subset of entries is identified according to the first fragment, the selection criteria, and the characteristic information. Entries in the first subset are then rearranged according to the sorting criteria and corresponding characteristic information. A first entry is then identified in the first subset, matching the sorting criteria. The rearranged first subset of entries is then displayed with the first entry highlighted.

Another embodiment provides a user interface system generating a dynamic selection menu. The user interface system comprises an input/output device, a processor, and a display device. The input/output device receives a first fragment comprising at least a portion of a desired entry. The processor identifies a first subset of entries according to the first fragment, preset selection criteria, and the characteristic information, rearranges the first subset of entries according to preset sorting criteria and corresponding characteristic information, and identifies a first entry from the first subset. The display device displays the rearranged first subset of entries with the first entry highlighted.

The aforementioned method may take the form of program code embodied in a tangible media. When the program code is loaded into and executed by a machine, the machine becomes an apparatus for executing embodiments of the invention.

A detailed description of embodiments of the invention is given in the following with reference to the accompanying drawings.

### BRIEF DESCRIPTION OF THE DRAWINGS

Embodiments of the invention can be more fully understood by reading the subsequent detailed description and examples with references made to the accompanying drawings, wherein:

FIG. 1 illustrates a computing environment according to embodiments of the invention;

FIG. 2 is a schematic view of a system providing a user interface according to embodiments of the invention;

FIG. 3 is a flowchart of a method providing a dynamic selection menu according to embodiments of the invention;

FIGS. 4A to 4C illustrate dynamic selection menus and supporting data storage according to embodiments of the invention;

FIGS. 5A to 5C illustrate dynamic selection menus and supporting data storage according to embodiments of the invention; and

FIG. 6 is a diagram of a storage medium storing a computer program providing the method according to embodiments of the invention.

### DETAILED DESCRIPTION

In the following detailed description of embodiments, reference is made to the accompanying drawings which form a part hereof, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is, therefore, not to be taken in a limiting sense, and the scope of the invention is only defined by the appended claims. The leading digit(s) of reference numbers appearing in the Figures correspond to the Figure number.

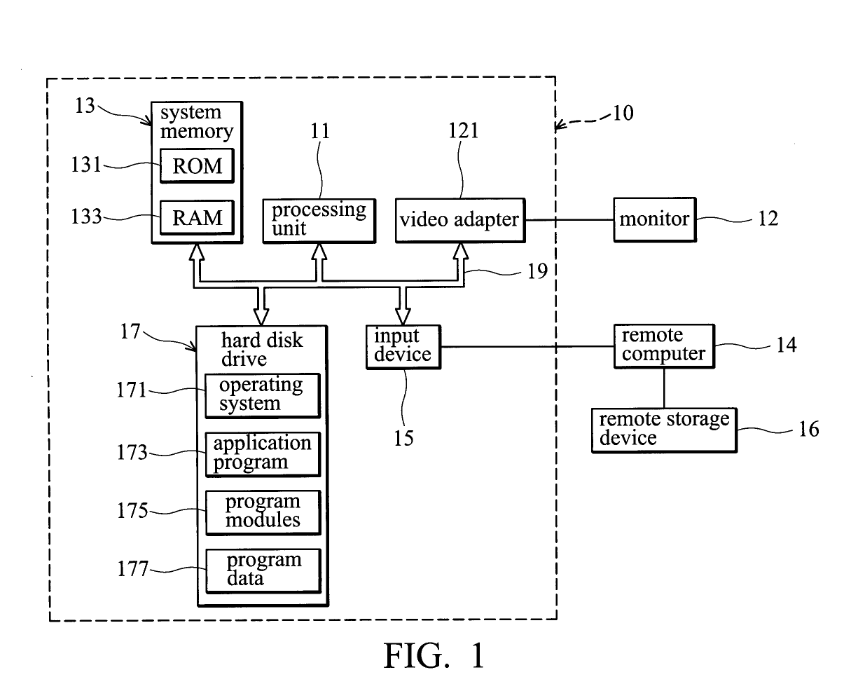

FIG. 1 provides a brief, general description of a suitable computing environment in which the invention may be implemented. Embodiments of the invention will hereinafter be described in the general context of computer-executable program modules, containing instructions executed by a personal computer (PC). Program modules include routines, programs, objects, components, data structures, etc. performing particular tasks or implementing particular abstract data types. Those skilled in the art will appreciate that the invention may be practiced with other computer-system configurations, including hand-held devices, multiprocessor systems, microprocessor-based programmable consumer electronics, network PCs, minicomputers, mainframe computers, and the like.

FIG. 1 illustrates a general-purpose computing device in the form of a personal computer 10, which comprises processing unit 11, system memory 13, and system bus 19. The system bus 19 couples the system memory 13 and other system components to processing unit 11. System bus 19 may be any of several types, including a memory bus or memory controller, a peripheral bus, and a local bus, and may use any of a variety of bus structures. System memory 13 includes read-only memory (ROM) 131 and random-access memory (RAM) 133. A basic input/output system (BIOS), stored in ROM 131, contains the basic routines that transfer information between components of personal computer 10. Personal computer 10 further comprises hard disk drive 17 reading from and writing to a hard disk (not shown). The drive and its associated computer-readable media provide nonvolatile storage of computer-readable instructions, data structures, program modules and other data for personal computer 10. Although the exemplary environment described herein employs a hard disk, those skilled in the art will appreciate that other types of computer-readable media which can store data accessible by a computer may also be used in the exemplary operating environment. Such media may include magnetic disks, optical disks, magnetic cassettes, flash-memory cards, digital versatile disks, and the like. Program modules may be stored on the hard disk 17, ROM 131, and RAM 133. Program modules may include operating system 171, one or more application program 173, other program modules 175, and program data 177. A user may enter commands and information into personal computer 10 through input device 15, such as a keyboard, pointing device, microphone, joystick, and the like. A monitor 12 or other display device also connects to system bus 19 via an interface such as a video adapter 121.

Personal computer 10 may operate in a networked environment using logical connections to one or more remote computers such as remote computer 14. Remote computer 14 may be another personal computer, a server, a router, a network PC, a peer device, or other common network nodes. Remote computer 14 typically includes many or all of the components described above in connection with personal computer 10, however, only a storage device 16 is illustrated in FIG. 1. The storage device 16 stores a service program 18, which provides a web-based information service to the personal computer 10. The remote computer 14 is connected to personal computer 10 through a local-area network (LAN) and/or a wide-area network (WAN). When placed in a LAN networking environment, personal computer 10 connects to the local network through a network interface or adapter (not shown). When used in a WAN networking environment such as the Internet, personal computer 10 typically includes a modem or other means for establishing communications over a WAN. In a network environment, program modules depicted as residing with personal computer 10 or portions thereof may be stored in remote storage device 16. Of course, the described network connections are illustrative, and other means of establishing a communications link between the computers may be substituted.

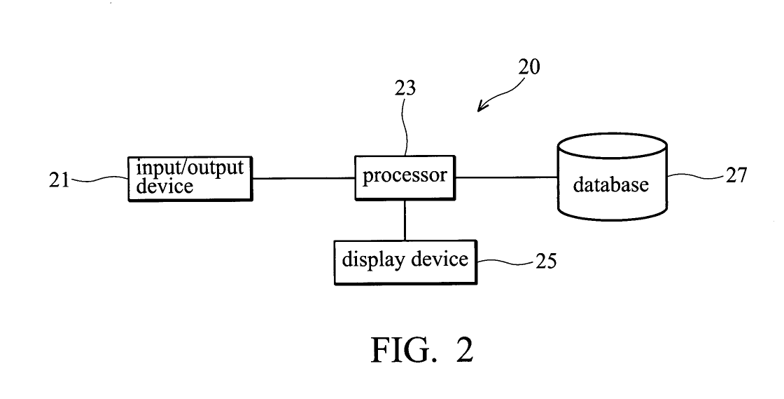

FIG. 2 is a schematic view of a user interface system according to embodiments of the invention. A user interface system 20 comprises an input/output device 21, a processor 23, and a display device 25. User interface system 20 links to a database 27 storing a plurality of entries associated with corresponding characteristic information. Input/output device 21 receives a first fragment constituting at least a portion of a desired entry. Processor 23 identifies a first subset of entries from database 27 according to the first fragment, preset selection criteria, and the characteristic information associated with the entries. Processor 23 also rearranges the first subset of entries according to preset sorting criteria and corresponding characteristic information. Additionally, processor 23 identifies an entry in the first subset, matching the sorting criteria. Display device 23, such as a monitor, displays the rearranged first subset of entries with the first entry highlighted.

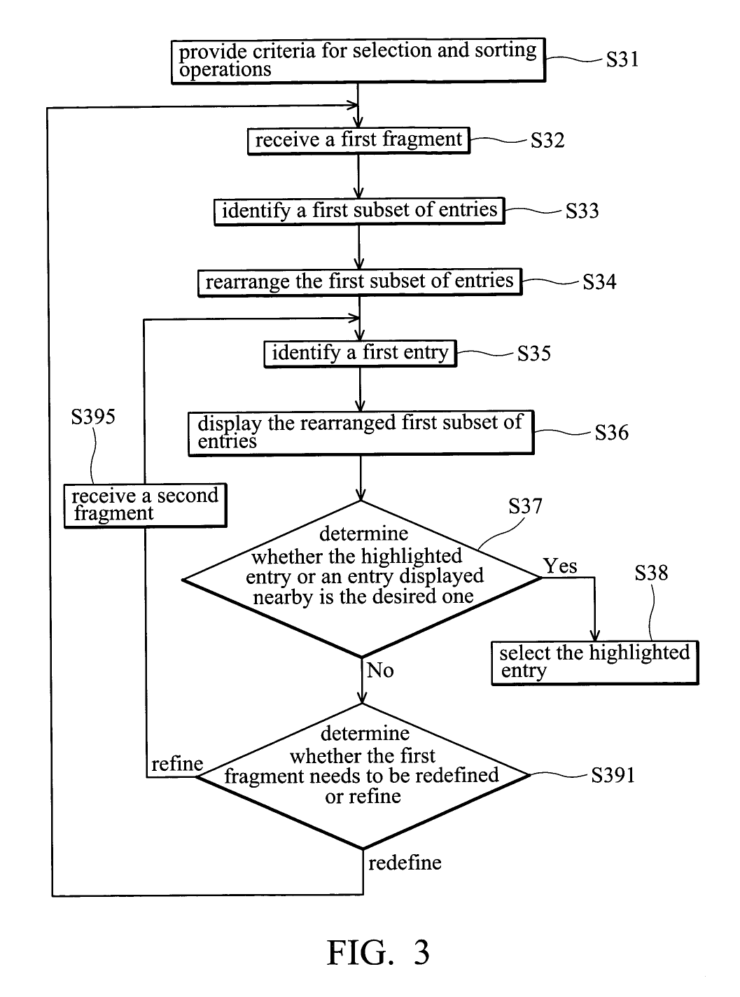

FIG. 3 is a flowchart of a method providing a dynamic selection menu according to embodiments of the invention. The method can be implemented in an environment as shown in FIG. 1, wherein a computer system connects to a database storing a plurality of entries associated with corresponding characteristic information. The characteristic information specifies a category pertaining to the corresponding entry. First, criteria for selection and sorting operations are provided (step S31). A first fragment is received, comprising at least one portion of a desired entry name (step S32).

The search criteria and sorting criteria can be defined to meet special needs. For example, the search criteria can be defined to require a category identical to the first fragment, or at least a portion of entry name identical to the first fragment; the sorting criteria can specify a sorting order of alphabetic, possibility, time sequence, or relevance.

A first subset of entries is then identified in the database according to the first fragment, the selection criteria, and the characteristic information (step S33). The identified first subset of entries is displayed in a list box in a control window.

The first subset of entries is then rearranged according to the sorting criteria and corresponding characteristic information (step S34). A first entry is then identified in the first subset, which matches the sorting criteria the most (step S35).

The rearranged first subset of entries is then displayed (step S36), wherein the first entry is highlighted enabling the user to locate a desired entry more easily.

It is then determined whether the highlighted entry or an entry displayed nearby is the desired one (step S37), and if so, the highlighted entry is selected (step S38), otherwise the process proceeds to step S391. In step S391, it is determined whether the first fragment needs to be redefined or refined. When a redefined search fragment is required, the process returns to step S32, when a refined search fragment is required, the process proceeds to step S395. In step S395, a second fragment of the search target is received, wherein a second entry in the first subset is identified. The second entry comprises the second fragment together with the first fragment and matches the search criteria.

The specific embodiment described below pertains to selection of a word from among a list of words. Thus, in this case, the “options” which a user is choosing among are the words in the list. The selection is made by entering “fragments”, in this case letters, in succession.

Embodiments of the invention described herein may also be applied to other cases in which the options are commands or search terms in a database. Moreover, larger or non-verbal items may be the “options”, in which case the fragments used for selection among the options may be Boolean operands, pictorial elements, or word combinations, for example.

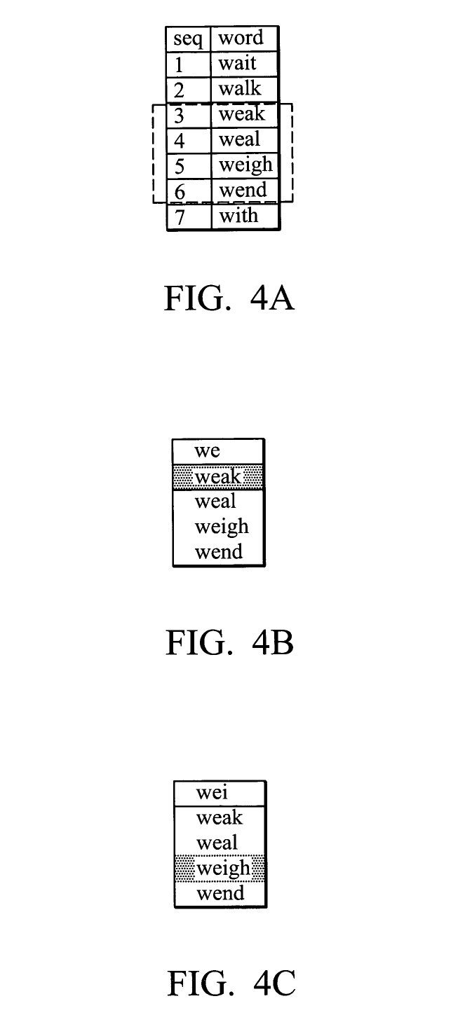

Referring to FIGS. 4A and 4B, the method of choosing a word from a list is illustrated as a first embodiment. As letters are typed, a list of entries is determined according to preset search and sorting criteria and an entry conforming to the typed letters is highlighted. A keystroke for a successive letter may cause a different entry to be highlighted to reflect the changing search fragments of entries. According to search criteria in this embodiment, entries having two initial letters identical to the entered letters are selected. Additionally, according to preset sorting criteria, selected entries are displayed in alphabetical order. For example, if a list consists of 7 entries as shown in FIG. 4A, typing W, then E, then I, would move the highlight and display screens shown in FIGS. 4B and 4C. According to the two-identical-initial criteria, only entries beginning with so far typed two letters, “WE”, are selected, as shown in FIG. 4B. Four entries are selected and the entry, which is the first one according to an alphabetical order, is highlighted. When a letter “I” is successively typed in, the highlight moves to the entry “weigh”, and the list remains unchanged.

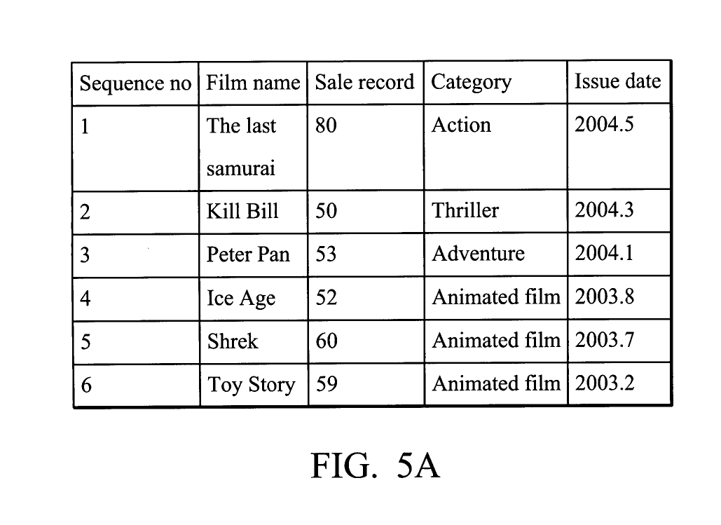

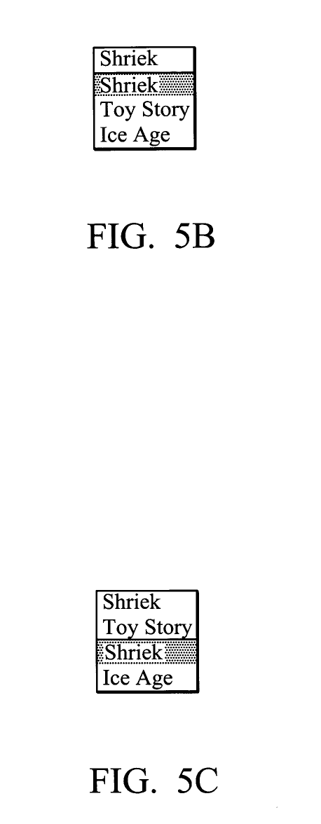

The search and sorting criteria can be specified to meet special needs, so long as supporting information is provided. Referring to FIGS. 5A and 5B, a second embodiment with altered search and sorting criteria is provided. A database storing film information is provided, wherein data structure thereof is shown in FIG. 5A. Seven entries are stored together with corresponding category and sales record information. According to the second embodiment, films pertaining to the category same with an input film name are selected, and the selected films are arranged according to corresponding sale record information. For example, when a film title, “Shriek” is input, it is first determined which category the film belongs to. Entries belonging to the same category are then selected and displayed in a list with a highlight cast on the entry “Shriek”, and entries in the list are arranged according to corresponding sale records, as shown in FIG. 5B. When the list is arranged under altered sorting criteria, for example, an issue date order, the list changes accordingly, as shown in FIG. 5C.

Generally, matching proceeds from left to right, selecting only entries with names beginning with the letters so far typed. Occasionally, however, particularly when the emphasis is on reducing the amount of typing, it may be advantageous to match a sequence of letters found anywhere in the name. This may be indicated by altering the search criteria.

The method of the various embodiments, or certain aspects or portions thereof, may take the form of program code (i.e. instructions) embodied in a tangible media, such as floppy diskettes, CD-ROMS, hard drives, or any other machine-readable storage medium, wherein, when the program code is loaded into and executed by a machine, such as a computer, the machine becomes an apparatus for practicing the method. The methods and apparatus of the invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

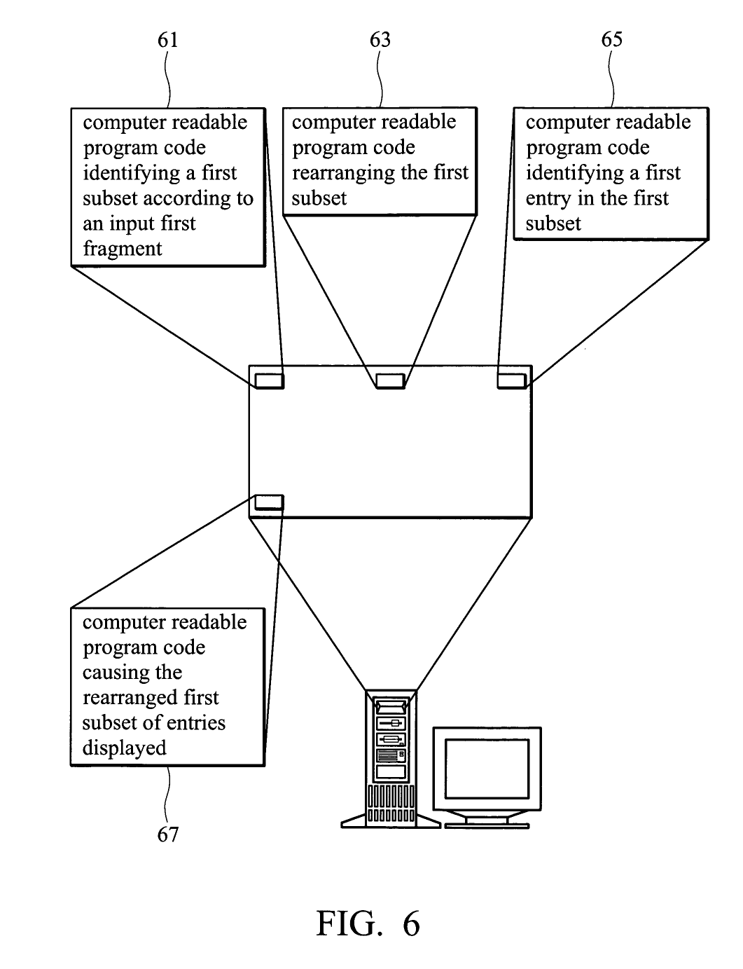

FIG. 6 is a diagram of a storage medium storing a computer program providing the method generating a dynamic selection menu. The computer program product comprises a computer usable storage medium having computer readable program code embodied in the medium, the computer readable program code comprising computer readable program code 61 identifying a first subset according to an input first fragment, preset selection criteria, and corresponding characteristic information, computer readable program code 63 rearranging the first subset according to preset sorting criteria and corresponding characteristic information, computer readable program code 65 identifying a first entry in the first subset, matching the sorting criteria, and computer readable program code 67 causing the rearranged first subset of entries displayed with the first entry highlighted.

While various embodiments of the invention have been described by way of example, it is to be understood that the invention is not limited to the disclosed embodiments. To the contrary, it is intended to cover various modifications and similar arrangements (as would be apparent to those skilled in the art).

What is claimed is:

1. A method for providing a dynamic selection menu, implemented in a computer system connecting to a database storing a plurality of entries associated with corresponding characteristic information, the method comprising the steps of:
providing criteria for selection and sorting operations;
receiving a first fragment comprising a portion of a desired entry;
identifying a first subset of entries according to the first fragment, the selection criteria, and the characteristic information;
rearranging the first subset of entries according to the sorting criteria and corresponding characteristic information;
identifying a first entry in the first subset, matching the sorting criteria; and
displaying the rearranged first subset of entries with the first entry highlighted.

2. The method of claim 1, wherein the characteristic information specifies a category corresponding to the entry.

3. The method of claim 2, wherein the search criteria require a category identical to the first fragment.

4. The method of claim 1, wherein the search criteria require at least a portion of an entry name identical to the first fragment.

5. The method of claim 1, further receiving an indicating signal for selecting one of the displayed entries.

6. The method of claim 1, wherein the sorting criteria specify an alphabetic order.

7. The method of claim 1, wherein the sorting criteria specify a possibility order.

8. The method of claim 1, wherein the sorting criteria specify a time sequence order.

9. The method of claim 1, wherein the sorting criteria specify a relevance order.

10. The method of claim 1, further comprising:
receiving a second fragment of the search target, which is another portion of a desired entry name successive to the first fragment; and
identifying a second entry in the first subset which comprises the second fragment together with the first fragment and matches the search criteria.

11. A system providing a dynamic selection menu, comprising:
an input/output device receiving a first fragment comprising a portion of a desired entry;
a processor identifying a first subset of entries according to the first fragment, preset selection criteria, and the characteristic information, rearranging the first subset of entries according to preset sorting criteria and corresponding characteristic information, and identifying a first entry in the first subset, matching the sorting criteria; and
a display device displaying the rearranged first subset of entries with the first entry highlighted.

12. The system of claim 11, further comprising a database storing a plurality of entries associated with corresponding characteristic information.

13. The system of claim 12, wherein the characteristic information specifies a category corresponding to the entry.

14. The system of claim 12, wherein the search criteria require a category identical to the first fragment.

15. The system of claim 11, wherein the search criteria require at least a portion of an entry name identical to the first fragment.

16. The system of claim 11, wherein the processor further receives an indicating signal for selecting one of the displayed entries.

17. The system of claim 11, wherein the processor further receives a second fragment of the search target, which is another portion of a desired entry name succeeding the first fragment, and identifies a second entry in the first subset which comprises the second fragment together with the first fragment and matches the search criteria.

18. A computer readable storage medium storing a computer program providing a method generating a dynamic selection menu, wherein the method is implemented in a computer system connecting to a database storing a plurality of entries associated with corresponding characteristic information, comprising:
receiving a first fragment comprising a portion of a desired entry;
identifying a first subset of entries according to the first fragment, preset selection criteria, and the characteristic information;
rearranging the first subset of entries according to preset sorting criteria and corresponding characteristic information;
identifying a first entry in the first subset, matching the sorting criteria; and
displaying the rearranged first subset of entries with the first entry highlighted.

19. The storage medium of claim 18, wherein the method further receives an indicating signal for selecting one of the displayed entries.

20. The storage medium of claim 18, wherein the method further comprises:
receiving a second fragment of the search target, which is another portion of a desired entry name successive to the first fragment; and
identifying a second entry in the first subset which comprises the second fragment together with the first fragment and matches the search criteria.
